(19) United States
(12) Patent Application Publication
(10) Pub. No.: US 2009/0024920 A1
(43) Pub. Date: Jan. 22, 2009

(54) Apparatus and method for extracting and using images from on-line forum posts and other web pages

(75) Inventors: Jesse D. Bulpitt, Keller, TX (US); Neal D. Rapoport, Plano, TX (US)

Correspondence Address: DOCKET CLERK, P.O. DRAWER 800889, DALLAS, TX, 75380, US

(73) Assignee: NARAE ENTERPRISES, INC., Plano, TX (US)

(21) Appl. No.: 11/879,098

(22) Filed: Jul. 16, 2007

(51) Int. Cl. G06F 3/00

(52) U.S. Cl. 715/700

(57) ABSTRACT

A request for a web page can be received from an end user device (such as a laptop or desktop computer or a handheld device). An image associated with the web page is retrieved, such as by identifying an image path to an image file associated with the image. The image path could be contained in an on-line forum post or other suitable location. At least one property of the retrieved image is altered to produce an altered image. The alteration of the at least one property of the image reduces a storage space for the altered image compared to a storage space for the image. The alteration could, for example, include decreasing a size, a resolution, or a color depth of the retrieved image. The web page with the altered image is then provided to the end user device.

### TECHNICAL FIELD

This disclosure is generally directed to computing systems and more specifically to an apparatus and method for extracting and using images from on-line forum posts and other web pages.

### BACKGROUND

Many different websites support on-line forums, or on-line discussions where users can post information and respond to one another. Forums typically allow users to start new discussions, where each discussion is often referred to as or is associated with a “thread.” Each thread typically includes a collection of “posts,” which represent comments from individual users about a particular topic or other users' comments.

As a particular example, some websites support deal-tracking forums. In these forums, users typically identify and discuss coupons, sales, or other discounts or “deals” associated with products or services offered by various on-line businesses or other entities. The first post in each thread in these deal-tracking forums may identify a discount associated with a product or service. Other users may then provide additional posts, such as posts commenting on the product or service, the business or other entity associated with the discount, or other users' posts. In some instances, one or more posts in a thread could include at least one image, such as one or more images of a product offered for sale.

### SUMMARY

This disclosure provides an apparatus and method for extracting and using images from on-line forum posts and other web pages.

In a first embodiment, a method includes receiving a request for a web page, retrieving an image associated with the web page, and altering at least one property of the image to produce an altered image. Altering the at least one property of the image reduces a storage space for the altered image compared to a storage space for the image. The method also includes providing the web page with the altered image.

In particular embodiments, altering the at least one property of the image includes decreasing a size, a resolution, and/or a color depth of the image.

In other particular embodiments, retrieving the image includes identifying an image path to an image file associated with the image. The image path is defined in a user post in a forum.

In yet other particular embodiments, the method also includes determining whether the image has previously been retrieved and altered. The retrieval of the image and the alteration of the at least one property of the image are done in response to determining that the image has not previously been retrieved and altered. The method may further include receiving a second request for the web page, retrieving a stored version of the altered image, and providing the web page with the retrieved altered image.

In still other particular embodiments, the image includes an image of a product associated with a user post in a forum, where the user post is associated with the product.

In a second embodiment, an apparatus includes at least one processor configured to receive a request for an image associated with a web page, retrieve the image, and alter at least one property of the image to produce an altered image. The alteration of the at least one property of the image reduces a storage space for the altered image compared to a storage space for the image. The apparatus also includes at least one memory configured to store the altered image.

In a third embodiment, a computer program is embodied on a computer readable medium. The computer program includes computer readable program code for receiving a request for an image associated with a web page, retrieving the image, altering at least one property of the image to produce an altered image, and storing the altered image. The alteration of the at least one property of the image reduces a storage space for the altered image compared to a storage space for the image.

In a fourth embodiment, a method includes receiving a request for an image, retrieving the image, altering at least one property of the image to produce an altered image, and storing the altered image. Altering the at least one property of the image reduces a storage space for the altered image compared to a storage space for the image.

In a fifth embodiment, an apparatus includes at least one processor configured to receive a request for a web page, where the web page is associated with an image. The at least one processor is also configured to generate a request for the image and to receive an altered version of the image. The altered version of the image has at least one property that has been altered to reduce a storage space for the altered version of the image compared to a storage space for the image. In addition, the apparatus includes at least one network interface configured to provide the web page with the altered version of the image.

In a sixth embodiment, a computer program is embodied on a computer readable medium. The computer program includes computer readable program code for receiving a request for a web page, where the web page is associated with an image. The computer program also includes computer readable program code for generating a request for the image and receiving an altered version of the image. The altered version of the image has at least one property that has been altered to reduce a storage space for the altered version of the image compared to a storage space for the image. In addition, the computer program includes computer readable program code for providing the web page with the altered version of the image.

In a seventh embodiment, a method includes receiving a request for a web page, where the web page is associated with an image. The method also includes generating a request for the image and receiving an altered version of the image. The altered version of the image has at least one property that has been altered to reduce a storage space for the altered version of the image compared to a storage space for the image. In addition, the method includes providing the web page with the altered version of the image.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example system for extracting and using images from on-line forum posts and other web pages according to this disclosure;

FIGS. 2 and 3 illustrate example web pages in which images are extracted and used according to this disclosure;

FIG. 4 illustrates an example method for using images from on-line forum posts and other web pages according to this disclosure; and

FIG. 5 illustrates an example method for extracting images from on-line forum posts and other web pages according to this disclosure.

### DETAILED DESCRIPTION

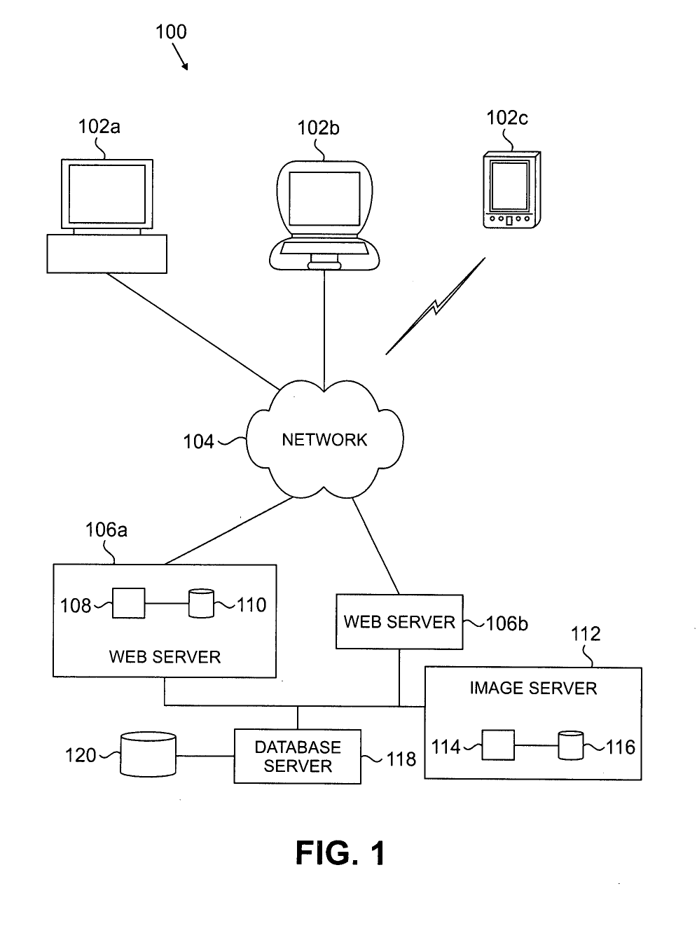

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example system 100 for extracting and using images from on-line forum posts and other web pages according to this disclosure. The embodiment of the system 100 shown in FIG. 1 is for illustration only. Other embodiments of the system 100 may be used without departing from the scope of this disclosure.

In this example embodiment, the system 100 includes various end user devices 102a-102c. Each of the user devices 102a-102c communicates over a network 104. For example, each of the user devices 102a-102c may receive and display web pages to a user, and the user could use the user device to provide information via the web pages (such as information identifying search criteria related to products or services). As described in more detail below, a web page received by a user device could contain images that have been extracted from other web pages (such as on-line forum posts) and resized for display in the current web page.

In this particular example, the user devices 102a-102c include a desktop computer (102a), a laptop computer (102b), and a personal digital assistant (102c). Each of these user devices 102a-102c communicates over a wired or wireless connection. These user devices 102a-102c are for illustration only. Any other or additional computing or communication devices may be used in the system 100. Each of the user devices 102a-102c includes any suitable structure allowing a user to communicate and interact over a network.

A network 104 facilitates communication between various components in the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate type of protocol or protocols, such as Ethernet, IP, X.25, frame relay, or any other protocol.

In this example, two web servers 106a-106b are coupled to the network 104. The web servers 106a-106b support communication and interaction with the user devices 102a-102c over the network 104. For example, the web servers 106a-106b may generate web pages and provide the web pages to the user devices 102a-102c over the network 104. As particular examples, the web servers 106a-106b may generate web pages that identify prices or discounts associated with one or more products or services. The web pages could also include images from on-line forum posts or other web pages that have been extracted and resized.

In this particular example, two web servers 106a-106b are shown as being coupled to the network 104. In this embodiment, both web servers 106a-106b could be used to facilitate communications with the user devices 102a-102c. Also, any suitable technique could be used to route individual user devices 102a-102c to specific ones of the web servers 106a-106b, such as by using load-sharing techniques.

The web servers 106a-106b could support additional functionality. For example, the web servers 106a-106b could support or provide a forum for users to interact. As a particular example, in a deal-tracking forum, users could identify and discuss discounts or other offers for products or services, as well as any other information associated with products or services provided by on-line businesses or other entities. In these embodiments, the web servers 106a-106b may allow the users to start new threads associated with particular topics and to post comments in existing threads. As part of this forum activity, users could embed or otherwise include images in forum posts, such as when a user includes an image of a product in a post regarding a sale of that product.

The web servers 106a-106b could use any suitable protocol(s) to communicate with the user devices 102a-102c. For example, the web servers 106a-106b could support the use of hypertext markup language (HTML) to communicate web pages to the user devices 102a-102c. The web servers 106a-106b could also support Secure Sockets Layer (SSL) or other techniques to facilitate secure communications with the user devices 102a-102c.

Each of the web servers 106a-106b includes any suitable structure for providing web pages to user devices. As a particular example, each of the web servers 106a-106b could include one or more processors 108, one or more network interfaces 109, and one or more memories 110 containing instructions and data used, generated, or collected by the one or more processors 108. The one or more network interfaces 109 facilitate communication over a network, such as an Ethernet interface that facilitates reception of resized images.

In this example, an image server 112 is coupled to or is otherwise accessible from the web servers 106a-106b. The image server 112 is capable of searching for and identifying images in on-line forum posts and other web sites. The image server 112 can also extract the identified images and process the images, such as by resizing the images to a smaller size or resolution. The image server 112 could further store the resized images.

The web servers 106a-106b can use the resized images generated by the image server 112 in any suitable manner, such as by including the resized images in web pages provided to the user devices 102a-102c. For example, when a web server 106a-106b generates a web page, the web server 106a-106b could request the first image (if any) from a particular forum post. The image server 112 could determine if any image from the particular forum post has been retrieved and processed previously by the image server 112. If not, the image server 112 can examine the forum post, identify an image (such as the first image), extract the image, and resize and store the image. If the image from the forum post has been retrieved and processed previously, the image server 112 can retrieve the previously-resized image associated with the forum post. In either case, the image server 112 could then make the resized image available to the web server 106a-106b for inclusion in a web page. Additional details regarding this functionality are provided below.

The image server 112 includes any suitable structure for extracting and resizing images from on-line forum posts or other web pages. As a particular example, the image server 112 could include one or more processors 114, one or more network interfaces 115, and one or more memories 116 containing instructions and data used, generated, or collected by the one or more processors 114. The one or more network interfaces 115 facilitate communication over a network, such as an Ethernet interface that facilitates transmission of resized images.

A database server 118 is coupled to the web servers 106a-106b, the image server 112, and a database 120. The database 120 stores various information used, collected, or generated by the web servers 106a-106b and the image server 112. For example, the database 120 could store information identifying prices and discounts for various products or services offered by on-line vendors. The database 120 could also store information identifying shipping costs, tax rates, addresses, payment information, and other information associated with the vendors. The database 120 could further store information associated with an on-line forum accessible through the web servers 106a-106b, such as information associated with the threads and posts in the forum. In addition, the database 120 could store resized images generated by the image server 112, which could be provided to the web servers 106a-106b for use in generating web pages for user devices.

The database server 118 provides access to and control over the data stored in the database 120. For example, the database server 118 can support the storage of data in and the retrieval of data from the database 120. The database server 118 may also ensure that components attempting to access the database 120 are authorized.

The database server 118 includes any suitable structure for providing access to a database of information. The database 120 includes any suitable structure for storing and facilitating retrieval of information. The database 120 also uses any of a variety of data structures, arrangements, and compilations to store and facilitate retrieval of information.

In one aspect of operation, the web servers 106a-106b receive requests for web pages, such as web pages containing pricing information related to products or services, from the user devices 102a-102c. In response, the web servers 106a-106b generate web pages satisfying the user devices' requests. The web pages being generated include images from one or more forum posts or other web pages. For example, users may request web pages associated with particular products or services or access a deal-tracking website's homepage, and in either case the web pages requested by the users could include information from various forum posts. The web servers 106a-106b request that the image server 112 provide one or more images from the forum posts or other web pages, such as by identifying a particular on-line forum post that may contain an image of a product. The image server 112 determines whether an image from each identified forum post or other web page has already been retrieved and processed. If an image from an identified forum post or other web page has not been processed previously, the image server 112 extracts and processes the image, such as by resizing an image extracted from a forum post to a smaller size or resolution. If an image from an identified forum post or other web page has been processed, the image server 112 retrieves the previously-processed image, such as from the database 120. The resized images are made available to the web servers 106a-106b for inclusion in the web pages.

This represents one example of how the system 100 may operate. The system 100 may operate in any other suitable manner. For example, the web servers 106a-106b could use resized images in any suitable manner. The web servers 106a-106b could also request the resized images in any suitable manner. The system 100 may operate in various other ways depending on the particular implementation of the web servers 106a-106b, the image server 112, or other components in the system 100.

Although FIG. 1 illustrates one example of a system 100 for extracting and using images from on-line forum posts and other web pages, various changes may be made to FIG. 1. For example, the system 100 may include any number of user devices, networks, web servers, image servers, database servers, and databases. Also, the functional division shown in FIG. 1 is for illustration only. Various components in FIG. 1 could be combined or omitted and additional components could be added according to particular needs. Further, the layout of the components shown in FIG. 1 is for illustration only. The components of the system 100 could be arranged in any other suitable manner, such as when the image server 112 is coupled to the network 104 and is accessed by the web servers 106a-106b over the network 104. In addition, while FIG. 1 illustrates one operational environment in which the extraction and use of images from on-line forum posts and other web pages can be supported, this functionality could be used in any other suitable system.

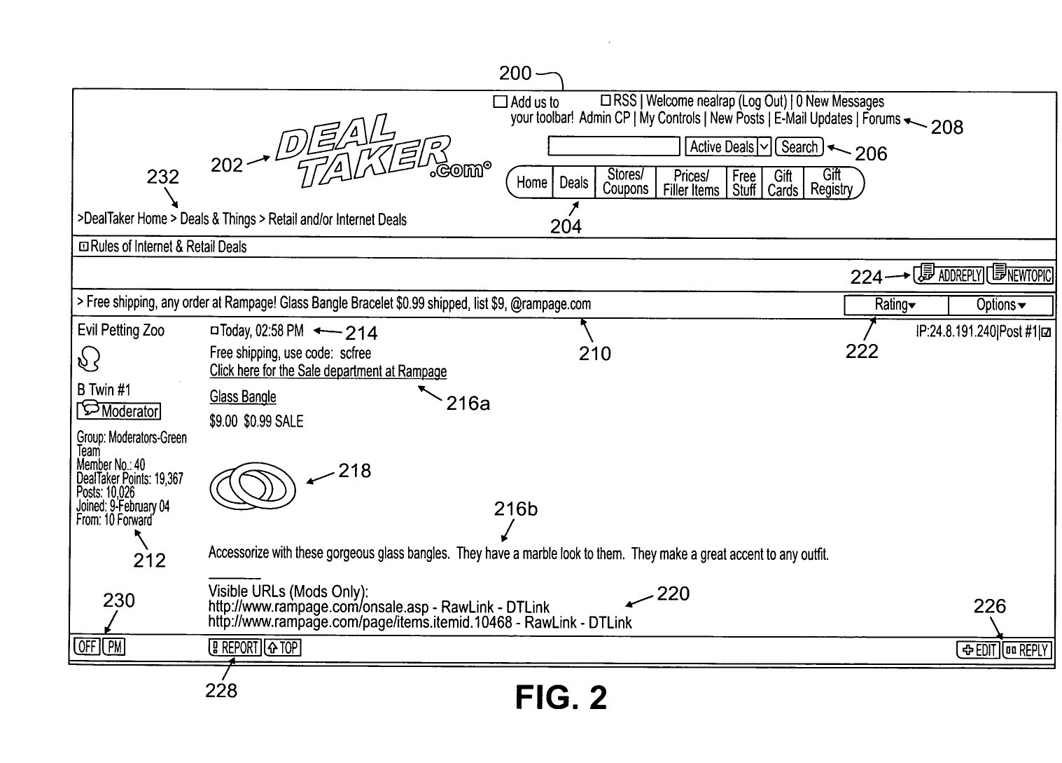

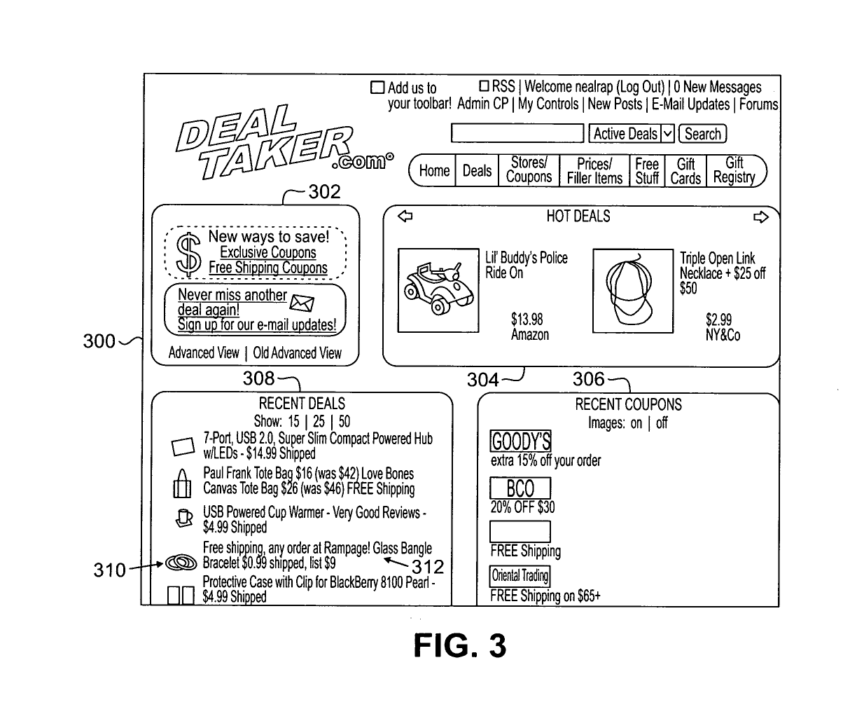

FIGS. 2 and 3 illustrate example web pages in which images are extracted and used according to this disclosure. In particular, FIG. 2 illustrates an example web page 200 containing a forum post with an image, and FIG. 3 illustrates an example web page 300 containing an extracted and resized version of the image from the forum post. The web pages 200 and 300 shown in FIGS. 2 and 3 are for illustration only. Other web pages could be used without departing from the scope of this disclosure.

As shown in FIG. 2, the web page 200 includes various information and controls at the top of the web page 200. For example, the web page 200 includes a logo 202 identifying the entity that owns or operates the website being accessed or that identifies the name of the website itself. The web page 200 also includes various tabs 204 used to access different types of information, such as information regarding on-line stores, products or services, or gift cards or registries.

The web page 200 also supports a text search 206, which allows a user to search for prices and other charges related to one or more products or services. For example, the user could enter text (such as a product name or product type), specify what type of search is desired (such as “prices” or “coupons”), and initiate the search.

The web page 200 further includes forum information and controls 208. As noted above, users may access and participate in on-line forums, such as a forum related to identifying and discussing discounts or other offers for products or services. In this example, the forum information and controls 208 identify the user's login name (if the user is currently logged into the forum) and the number of messages awaiting the user, while also giving the user an option to log out of the forum. The forum information and controls 208 also allow the user to access an administrator control panel (CP) and other controls for controlling the user's account and other aspects of the user's participation in the forum. The forum information and controls 208 further allow the user to view new posts in the forum, to view any e-mail updates for the user, and to access particular areas of the forum. Any other or additional forum information and controls 208 could be presented in the web page 200.

As shown in FIG. 2, the web page 200 displays a thread having one or more forum posts 210. In this example, the forum post 210 represents a post related to a particular product. The forum post 210 here includes user information 212, which identifies the user who created the forum post 210 and other user-related information. In this example embodiment, the user information 212 includes the username of the user who created the forum post 210, any taglines or symbols associated with that user, and the administrative level of that user (“moderator” in this case, meaning this user can moderate and revise/delete other users' posts). The user information 212 also includes various other information, such as group affiliations involving the user, the number of posts created by the user, and the date that the user joined the forum. Any other suitable information could be provided in the user information 212.

In this example, the forum post 210 also includes a timestamp 214 showing when the forum post 210 was added to the forum. The forum post 210 further includes text 216a-216c and an image 218. The text 216a-216c in this example includes a title of the thread or post, a price and a description of a product, links for purchasing the product or locating additional information about the product, and a discount code for use when purchasing the product. The image 218 here represents an image of the product being offered for sale. When the user accessing the forum post 210 is a moderator, additional information can be provided in the forum post 210, such as Uniform Resource Locators (URLs) 220 or other paths associated with hyperlinks contained in the text (in this case, two links contained in the text 216b).

Various other buttons, menus, and other controls are available for use in the web page 200. For example, drop-down buttons 222 can be used to select various functions. In this example, a “Rating” drop-down button 222 can be selected to display a list of ratings, which can be selected by a user for rating a particular forum thread. This may allow, for example, the web servers 106a-106b to present users with the highest-rated threads when the user first accesses the forum or other web page. An “Options” drop-down button 222 can be selected to display a list of functions or other options that can be selected by the user. Example options could include tracking a thread, e-mailing the thread to a specified e-mail address, and printing the thread. Other options could include subscribing to a forum and “Digg”-ing a thread (or otherwise associating the thread with a collection of community-driven hyperlinks and other web-based content).

Other controls in the web page 200 include buttons 224, which allow a user to add a reply or other comment to the currently-viewed thread or to create a new topic/thread. Buttons 226 allow a user to edit a particular post or to add a reply or other comment to a particular post in a thread. Buttons 228 allow a user to report a particular thread or post (such as a post that does not comply with other rules of the forum) or to return to the top of a thread. In addition, buttons 230 allow a user to control whether the user receives private messages (PMs) about the particular thread or in general. Navigation text 232 allows a user to view where the user is currently located within the forum, and it may allow the user to navigate to higher levels of the forum.

As shown here, the forum post 210 includes one or more images 218. In this example, the image 218 represents an image of a product offered for sale. The operator of the web page 200 may wish the image 218 in the forum post 210 to be made available and displayed in other web pages. An example of this is shown in FIG. 3, which illustrates a web page 300 containing an extracted and resized version of the image 218 from the forum post 210.

In FIG. 3, the top portion of the web page 300 is the same as or similar to the top portion of the web page 200 in FIG. 2. The web page 300 in this example also includes various deal-tracking information associated with products or services. For example, the web page 300 includes a section 302 that allows users to register to receive notifications associated with various deal-tracking offers. The web page 300 also includes a section 304 identifying specific offers for products or services, such as product or service offers identified by forum users or web site administrators as being particularly good. The web page 300 further includes a section 306 identifying recent coupons or other discounts associated with particular entities, such as on-line businesses.

In addition, the web page 300 includes a section 308 identifying recent deals or other discounts or offers associated with products or services. In some embodiments, the offers listed in section 308 are based on the product or service offers identified by users in a forum. In particular embodiments, the offers presented in section 308 could be selected from a larger set of offers based on user ratings given to the forum posts 210 (such as by using the “Rating” drop-down button 222). The offers presented in section 308 could also be selected for a particular user based on that user's specified preferences or various information (such as a user profile) derived based on the user's past purchasing or viewing history.

As shown here in FIG. 3, the section 308 includes an image 310 and description 312 associated with the forum post 210 shown in FIG. 2. The description 312 may be the same as or similar to the title of the forum post 210. The image 310 represents a resized version of the image 218 contained in the forum post 210. For example, the image 310 could have a lower resolution or a smaller size compared to the original image 218 in the forum post 210. If a forum post without an image is ranked high enough or otherwise selected for listing in the section 308, a “No Image Available” picture or other suitable image (or no image at all) could be displayed in the section 308.

This represents a single example of how a resized image from a forum post or other web page could be used. Resized images from forum posts or other web pages could be used in any other suitable manner and for any other suitable purpose.

Although FIGS. 2 and 3 illustrate examples of web pages in which images are extracted and used, various changes may be made to FIGS. 2 and 3. For example, a web page supporting the creation or display of forum posts could have any other suitable form, as could the forum posts themselves. Also, any suitable web page could display extracted and resized images for any purpose, whether or not that purpose is related to deal-tracking functions.

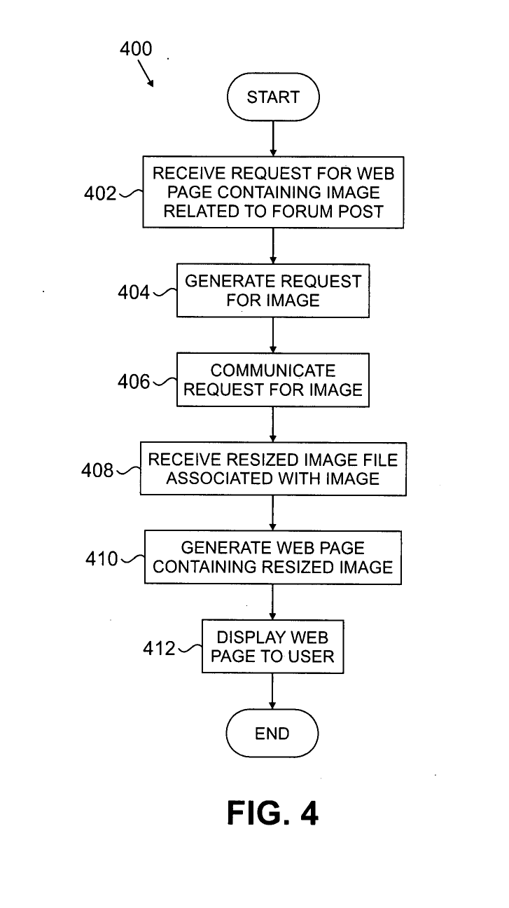

FIG. 4 illustrates an example method for using images from on-line forum posts and other web pages according to this disclosure. The embodiment of the method 400 shown in FIG. 4 is for illustration only. Other embodiments of the method 400 could be used without departing from the scope of this disclosure. Also, for ease of explanation, the method 400 is described with respect to the web pages 200 and 300 of FIGS. 2 and 3 being used in the system 100 of FIG. 1. The method 400 could be used with any suitable web pages generated or used in any suitable system.

A request for a web page containing an image related to a forum post is received from a user at step 402. This could include, for example, a web server 106a-106b receiving a request for a particular web page (such as web page 300) from a user device 102a-102c over the network 104. As described above, the web page 300 could include one or more images from one or more forum posts related to various products or services.

A request for the image related to the forum post is generated at step 404 and communicated at step 406. This could include, for example, the web server 106a-106b identifying a unique identifier associated with the forum post. This could also include the web server 106a-106b communicating a request containing the unique forum post identifier to the image server 112. As a particular example, the web server 106a-106b could request an image from a forum post using a pre-defined image path, such as http://images.dealtaker.com/homepage_posts/piXXXXXX.img (where XXXXXX represents the unique forum post identifier). In response to this request, the image server 112 extracts an image (such as the first image) from the identified forum post and resizes the image, or the image server 112 retrieves a previously-processed image from the database 120.

A resized image file associated with a resized version of the image from the forum post is received at step 408. This could include, for example, the web server 106a-106b receiving a file containing a smaller version of the image from the identified forum post.

A web page containing the resized image is generated at step 410 and is displayed to the user at step 412. This could include, for example, the web server 106a-106b generating a web page 300 that contains the resized image from a forum post 210. This could also include the web server 106a-106b communicating the web page 300 using HTML to the user device 102a-102c used by the user. This may further include the user device 102a-102c presenting the generated web page 300 to the user.

Although FIG. 4 illustrates one example of a method for using images from on-line forum posts and other web pages, various changes may be made to FIG. 4. For example, while the method 400 is shown as using resized images associated with forum posts, the same or similar technique could be used with resized images from other web pages. Also, while shown as requesting an image from a forum post using a particular forum post identifier, any other suitable technique could be used to identify a forum post or thread from which an image is requested (such as a thread identifier). In addition, while shown as a series of steps, various steps in FIG. 4 could overlap, occur in parallel, or occur in a different order.

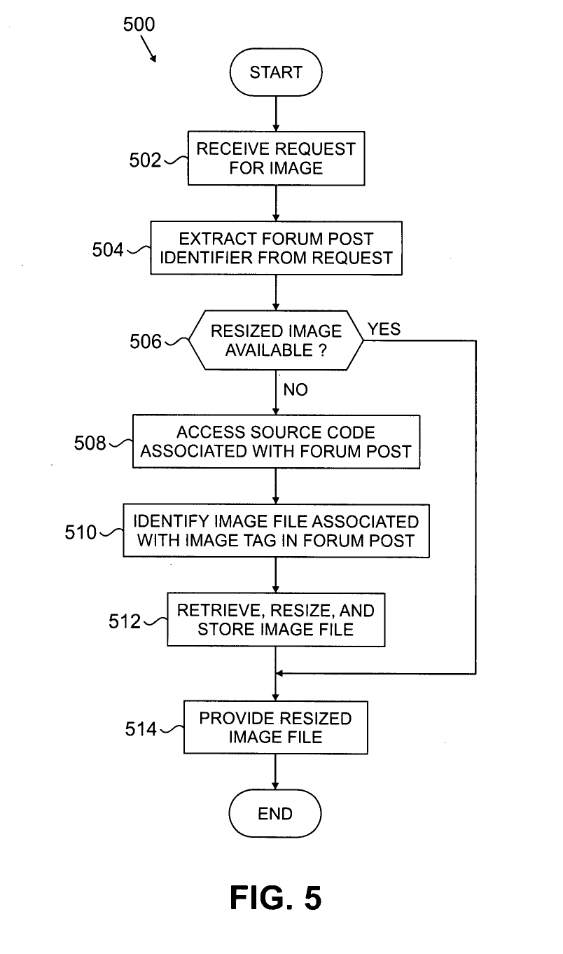

FIG. 5 illustrates an example method 500 for extracting images from on-line forum posts and other web pages according to this disclosure. The embodiment of the method 500 shown in FIG. 5 is for illustration only. Other embodiments of the method 500 could be used without departing from the scope of this disclosure. Also, for ease of explanation, the method 500 is described with respect to the web pages 200 and 300 of FIGS. 2 and 3 being used in the system 100 of FIG. 1. The method 500 could be used with any suitable web pages generated or used in any suitable system.

A request for an image related to a forum post is received at step 502. This could include, for example, the image server 112 receiving the request from a web server 106a-106b. The request could contain a unique identifier associated with the forum post, such as when the request includes or identifies an image path like http://images.dealtaker.com/homepage_posts/piXXXXXX.img. A forum post identifier is extracted from the request at step 504. This could include, for example, the image server 112 identifying the XXXXXX value contained in the image path from the request.

A determination is made whether a resized image associated with the identified forum post is already available at step 506. This may include, for example, the image server 112 accessing the database 120 to determine if a resized image associated with the XXXXXX forum post identifier is available. If so, the method 500 skips to step 514, where the resized image is provided. This could include, for example, the image server 112 retrieving the resized image from the database 120 and providing the resized image to the web server 106a-106b.

Otherwise, the source code associated with the identified forum post is accessed at step 508. This could include, for example, the image server 112 accessing the database 120 and then accessing the code defining the contents of a forum post 210. Among other things, the source code typically identifies the text from the forum post 210 and any paths (such as URLs) to images contained in the forum post 210.

An image file associated with an image tag in the forum post is identified at step 510. This could include, for example, the image server 112 identifying a tag that indicates a URL or other path represents a path to an image. As a particular example, the image server 112 could identify the first image tag in the forum post (although one or more other or additional image tags could also be identified). The identified path represents a path to a file containing an image displayed in the forum post.

The identified image file is then retrieved, altered (if necessary), and stored at step 512. This could include, for example, retrieving the image file using the URL or other path associated with the identified image tag. The alteration of the image could involve any suitable change to one or more properties of the image that can reduce the storage space requirements for the image, such as a change to the size, resolution, color depth, or any other property or properties of the image. As a particular example, the resized image could have a size of 40×40 pixels, a resolution of 96 dots per inch (DPI) in both the horizontal and vertical directions, and a 24-bit color depth. Note that resizing may not be required if the image from the forum post already has all of the desired properties. The resized image can then be saved in the database 120, such as by saving the image as a Joint Photographic Experts Group (JPEG) file. The resized image is provided at step 514.

Although FIG. 5 illustrates one example of a method 500 for extracting images from on-line forum posts and other web pages, various changes may be made to FIG. 5. For example, while the method 500 is shown as resizing images associated with forum posts, the same or similar technique could be used to resize images from other web pages. Also, while shown as resizing a single image from a forum post, the same or similar technique could be used to resize any number of images from a forum post or other web page. Further, while shown as extracting an image from a forum post using a particular forum post identifier, any other suitable technique could be used to identify a forum post or thread from which an image is extracted (such as a thread identifier). In addition, while shown as a series of steps, various steps in FIG. 5 could overlap, occur in parallel, or occur in a different order.

Moreover, FIGS. 4 and 5 have been described as being performed by different devices (the web servers 106a-106b for FIG. 4 and the imaging server 112 for FIG. 5). However, the methods 400 and 500 could be combined and implemented using a single device, such as a single server supporting the functions of the web servers 106a-106b and the image server 112. In these embodiments, requests for a particular image and the resized image itself need not be transmitted between servers or other devices, and the appropriate steps (such as various requesting and receiving steps) can be omitted.

In some embodiments, various functions described above can be implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. A method comprising:
receiving a request for a web page;
retrieving an image associated with the web page;
altering at least one property of the image to produce an altered image, wherein altering the at least one property of the image reduces a storage space for the altered image compared to a storage space for the image; and
providing the web page with the altered image.

2. The method of claim 1, wherein altering the at least one property of the image comprises decreasing at least one of: a size, a resolution, and a color depth of the image.

3. The method of claim 1, wherein retrieving the image comprises identifying an image path to an image file associated with the image, the image path defined in a user post in a forum.

4. The method of claim 1, further comprising:
storing the altered image.

5. The method of claim 4, further comprising:
determining whether the image has previously been retrieved and altered;
wherein retrieving the image and altering the at least one property of the image are done in response to determining that the image has not previously been retrieved and altered.

6. The method of claim 5, further comprising:
receiving a second request for the web page;
retrieving the stored altered image; and
providing the web page with the retrieved altered image.

7. The method of claim 1, wherein the image comprises an image of a product associated with a user post in a forum, the user post associated with the product.

8. An apparatus comprising:
at least one processor configured to:
receive a request for an image associated with a web page;
retrieve the image; and
alter at least one property of the image to produce an altered image, wherein the alteration of the at least one property of the image reduces a storage space for the altered image compared to a storage space for the image; and
at least one memory configured to store the altered image.

9. The apparatus of claim 8, further comprising a network interface configured to transmit the altered image.

10. The apparatus of claim 8, wherein the at least one processor is configured to alter the at least one property of the image by decreasing at least one of: a size, a resolution, and a color depth of the image.

11. The apparatus of claim 8, wherein:
the request for the image comprises an identifier associated with at least one of: a thread and a post in a forum;
the at least one processor is further configured to identify the identifier; and
the at least one processor is configured to retrieve the image from at least one of the thread and the post.

12. The apparatus of claim 11, wherein the at least one processor is configured to retrieve a first image contained in at least one of the thread and the post.

13. The apparatus of claim 8, wherein:
the at least one processor is further configured to determine whether the image has previously been retrieved and altered; and
the at least one processor is configured to retrieve the image and to alter the at least one property of the image in response to a determination that the image has not previously been retrieved and altered.

14. The apparatus of claim 13, wherein the at least one processor is further configured to:
receive a second request for the web page;
retrieve the stored altered image; and
provide the web page with the retrieved altered image.

15. A computer program embodied on a computer readable medium, the computer program comprising computer readable program code for:
receiving a request for an image associated with a web page;
retrieving the image;
altering at least one property of the image to produce an altered image, wherein the alteration of the at least one property of the image reduces a storage space for the altered image compared to a storage space for the image; and
storing the altered image.

16. The computer program of claim 15, further comprising computer readable program code for providing the web page with the altered image.

17. The computer program of claim 15, wherein the computer readable program code for altering the at least one property of the image comprises computer readable program code for decreasing at least one of: a size, a resolution, and a color depth of the image.

18. The computer program of claim 15, wherein:
the request for the image comprises an identifier associated with at least one of: a thread and a post in a forum;
the computer program further comprises computer readable program code for identifying the identifier; and
the computer readable program code for retrieving the image comprises computer readable program code for retrieving the image from at least one of the thread and the post.

19. The computer program of claim 18, wherein the computer readable program code for retrieving the image comprises computer readable program code for retrieving a first image contained in at least one of the thread and the post.

20. The computer program of claim 15, further comprising computer readable program code for determining whether the image has previously been retrieved and altered;
wherein the computer readable program code for retrieving the image and altering the at least one property of the image comprises computer readable program code for retrieving the image and altering the at least one property of the image in response to a determination that the image has not previously been retrieved and altered.

21. The computer program of claim 20, further comprising computer readable program code for:
retrieving the stored altered image in response to a second request for the web page; and
providing the web page with the retrieved altered image.

22. A method comprising:
receiving a request for an image;
retrieving the image;
altering at least one property of the image to produce an altered image, wherein altering the at least one property of the image reduces a storage space for the altered image compared to a storage space for the image; and
storing the altered image.

23. An apparatus comprising:
at least one processor configured to:
receive a request for a web page, the web page associated with an image;
generate a request for the image; and
receive an altered version of the image, the altered version of the image having at least one property that has been altered to reduce a storage space for the altered version of the image compared to a storage space for the image; and
at least one network interface configured to provide the web page with the altered version of the image.

24. The apparatus of claim 23, further comprising a memory configured to store the altered version of the image.

25. The apparatus of claim 23, wherein the at least one property of the altered version of the image, compared to the image, has at least one of: a decreased size, a decreased resolution, and a decreased color depth.

26. The apparatus of claim 23, wherein:
the at least one processor is further configured to identify an identifier associated with at least one of: a thread and a post in a forum; and
the at least one processor is configured to generate the request for the image by generating a request containing the identifier.

27. The apparatus of claim 26, wherein the request comprises a Uniform Resource Locator containing the identifier.

28. A computer program embodied on a computer readable medium, the computer program comprising computer readable program code for:
receiving a request for a web page, the web page associated with an image;
generating a request for the image;
receiving an altered version of the image, the altered version of the image having at least one property that has been altered to reduce a storage space for the altered version of the image compared to a storage space for the image;
providing the web page with the altered version of the image.

29. The computer program of claim 28, further comprising computer readable program code for storing the altered version of the image.

30. The computer program of claim 28, wherein the at least one property of the altered version of the image, compared to the image, has at least one of: a decreased size, a decreased resolution, and a decreased color depth.

31. The computer program of claim 28, further comprising computer readable program code for identifying an identifier associated with at least one of: a thread and a post in a forum;
wherein the computer readable program code for generating the request for the image comprises computer readable program code for generating a request containing the identifier.

32. A method comprising:
receiving a request for a web page, the web page associated with an image;
generating a request for the image;
receiving an altered version of the image, the altered version of the image having at least one property that has been altered to reduce a storage space for the altered version of the image compared to a storage space for the image; and
providing the web page with the altered version of the image.
